(19) United States
(12) Patent Application Publication
(10) Pub. No.: US 2025/0321243 A1
(43) Pub. Date: Oct. 16, 2025

(54) INFORMATION PROCESSING SYSTEM, INFORMATION PROCESSING APPARATUS, INFORMATION PROCESSING METHOD, AND STORAGE MEDIUM

(71) Applicant: NEC Corporation, Tokyo (JP)

(72) Inventors: Takashi Shibata, Tokyo (JP); Takashi Takeuchi, Tokyo (JP); Takuya Ogawa, Tokyo (JP); Masahiro Yamaguchi, Tokyo (JP); Hiroyoshi Miyano, Tokyo (JP); Toshinori Hosoi, Tokyo (JP); Yuichi Abe, Tokyo (JP); Motoki Masaka, Tokyo (JP); Shoko Wakizaka, Tokyo (JP)

(73) Assignee: NEC Corporation, Tokyo (JP)

(21) Appl. No.: 19/171,434

(22) Filed: Apr. 7, 2025

(30) Foreign Application Priority Data
Apr. 12, 2024 (JP) 2024-064945

(51) Int. Cl. G01P 13/00

(52) U.S. Cl. CPC G01P 13/00

(57) ABSTRACT

At least one processor included in an information processing system carries out: an acquisition process for acquiring a plurality of pieces of sensor data; a trajectory candidate generation process for generating trajectory candidates related to a target object with reference to pieces of sensor data that have been acquired in the past; a selection process for selecting pieces of sensor data indicating a position of the target object from among the acquired pieces of sensor data; a trajectory group generation process for generating a trajectory group of the target object in accordance with a correlation between the trajectory candidates; and an output process for outputting the selected pieces of sensor data and the trajectory group.

This Nonprovisional application claims priority under 35 U.S.C. § 119 on Patent Application No. 2024-064945 filed in Japan on Apr. 12, 2024, the entire contents of which are hereby incorporated by reference.

### TECHNICAL FIELD

The present disclosure relates to an information processing system, an information processing apparatus, an information processing method, and a storage medium.

### BACKGROUND ART

Techniques for tracking a target object are known. For example, Patent Literature 1 discloses a multiple evaluation integrated analysis apparatus that detects a plurality of trajectories from observation signals of a plurality of acoustic sensors and determines coincidence between the plurality of trajectories.

### CITATION LIST

### Patent Literature

### [Patent Literature 1]

Japanese Patent Application Publication Tokukai No. 2005-17240

### SUMMARY OF INVENTION

### Technical Problem

A configuration in which many pieces of sensor data are referred to as in the multiple evaluation integrated analysis apparatus described in Patent Literature 1 has a problem that calculation load increases. On the other hand, a configuration in which, instead of the sensor data, trajectories detected by sensors are referred to decreases calculation load. However, if there is an error in the detection of the trajectory by each sensor, such a configuration cannot correct the error and thus decreases the accuracy. Therefore, a technique for tracking a target object at low load and with a high degree of accuracy has been required.

The present disclosure has been made in view of the above problem, and an example object of the present disclosure is to provide a technique and the like for tracking a target object at low load and with a high degree of accuracy.

### Solution to Problem

An information processing system in accordance with an example aspect of the present disclosure includes at least one processor, the at least one processor carrying out: an acquisition process for acquiring respective pluralities of pieces of sensor data from a plurality of sensors that detect a position of a target object; a trajectory candidate generation process, which is carried out for each of the plurality of sensors, for generating at least one trajectory candidate related to the target object with reference to pieces of sensor data that have been acquired in a past from each of the plurality of sensors and that each indicate a position of the target object; a selection process, which is carried out for each of the plurality of sensors, for selecting, with reference to the at least one trajectory candidate related to the target object, a piece of sensor data indicating the position of the target object from among the pieces of sensor data that have been acquired from each of the plurality of sensors; a trajectory group generation process for generating a trajectory group of the target object in accordance with a correlation between the trajectory candidates corresponding to respective ones of the plurality of sensors; and an output process for outputting the selected pieces of sensor data and the trajectory group.

An information processing apparatus in accordance with an example aspect of the present disclosure includes at least one processor, the at least one processor carrying out: an acquisition process for acquiring: pieces of sensor data that have been selected as sensor data indicating a position of a target object from among respective pluralities of pieces of sensor data which have been acquired from a plurality of sensors that detect a position of the target object; and a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object; an update process for updating a trajectory of the target object with reference to the selected pieces of sensor data and the trajectory group of the target object; a prediction process for predicting at least one future trajectory of the target object with reference to the updated trajectory; and an output process outputting a predicted consolidation trajectory group, which is the at least one trajectory having been predicted in the prediction process, to an apparatus that selects the pieces of sensor data and an apparatus that generates the trajectory group of the target object.

An information processing method in accordance with an example aspect of the present disclosure includes: an acquisition process for at least one processor acquiring respective pluralities of pieces of sensor data from a plurality of sensors that detect a position of a target object; a trajectory candidate generation process, which is carried out for each of the plurality of sensors, for the at least one processor generating at least one trajectory candidate related to the target object with reference to pieces of sensor data that have been acquired in a past from each of the plurality of sensors and that each indicate a position of the target object; a selection process, which is carried out for each of the plurality of sensors, for the at least one processor selecting, with reference to the at least one trajectory candidate related to the target object, a piece of sensor data indicating the position of the target object from among the pieces of sensor data that have been acquired from each of the plurality of sensors; a trajectory group generation process for the at least one processor generating a trajectory group of the target object in accordance with a correlation between the trajectory candidates corresponding to respective ones of the plurality of sensors; and an output process for the at least one processor outputting the selected pieces of sensor data and the trajectory group.

### Advantageous Effects of Invention

An example aspect of the present disclosure brings about an example effect of making it possible to provide a technique and the like for tracking a target object at low load and with a high degree of accuracy.

### BRIEF DESCRIPTION OF DRAWINGS

FIG. 1 is a block diagram illustrating a configuration of an information processing system in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing system in accordance with the present disclosure.

FIG. 6 is a flowchart illustrating a flow of an information processing method in accordance with the present disclosure.

FIG. 7 is a view illustrating an overview of an information processing system in accordance with the present disclosure.

FIG. 8 is a block diagram illustrating configurations of an information processing system and information processing apparatus in accordance with the present disclosure.

FIG. 9 is a view illustrating an example of a trajectory candidate in accordance with the present disclosure.

FIG. 10 is a view illustrating an example of sensor data and selected sensor data in accordance with the present disclosure.

FIG. 11 is a view illustrating an example of a trajectory group in accordance with the present disclosure.

FIG. 12 is a view illustrating an example of a predicted consolidation trajectory in accordance with the present disclosure.

FIG. 13 is a sequence diagram illustrating a flow of processes that are carried out in an information processing system in accordance with the present disclosure.

FIG. 14 is a block diagram illustrating a configuration of a computer that functions as an information processing system or an information processing apparatus in accordance with the present disclosure.

### DESCRIPTION OF EMBODIMENTS

The example embodiments of the present invention will be exemplified in the following description. It should be noted that the present invention is not limited to the example embodiments described below, but may be altered in various ways by a skilled person within the scope of the claims. For example, any example embodiment derived by appropriately combining technical means employed in the example embodiments described below can also be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment which is an example of an embodiment of the present invention will be described in detail with reference to the drawings. The present example embodiment is a basic form of each example embodiment described later. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Configuration of Information Processing System 1)

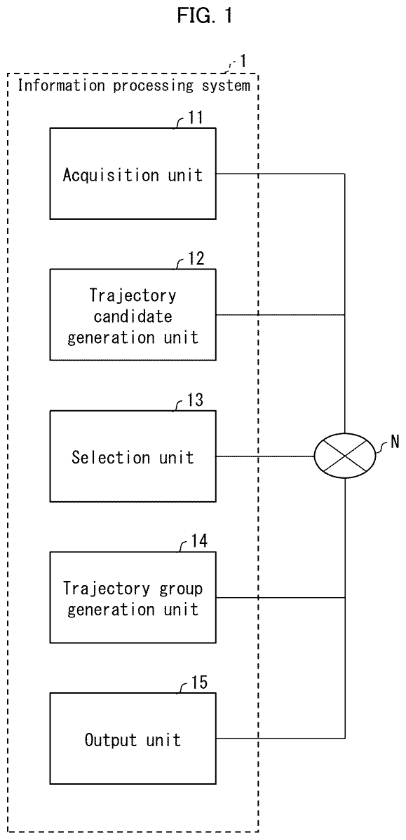

A configuration an information processing of system 1 will be described with reference to FIG. 1. FIG. 1 is a block diagram illustrating the configuration of the information processing system 1.

The information processing system 1 includes an acquisition unit 11, a trajectory candidate generation unit 12, a selection unit 13, a trajectory group generation unit 14, and an output unit 15, as illustrated in FIG. 1. The acquisition unit 11, the trajectory candidate generation unit 12, the selection unit 13, the trajectory group generation unit 14, and the output unit 15 realize an acquisition means, a trajectory candidate generation means, a selection means, a trajectory group generation means, and an output means, respectively, in the present example embodiment.

The acquisition unit 11, the trajectory candidate generation unit 12, the selection unit 13, the trajectory group generation unit 14, and the output unit 15 are connected to a network N so as to be able to communicate with each other, as illustrated in FIG. 1. However, the configuration of the information processing system 1 is not limited to such a configuration. The information processing system 1 may be configured such that one apparatus includes the acquisition unit 11, the trajectory candidate generation unit 12, the selection unit 13, the trajectory group generation unit 14, and the output unit 15. Alternatively, the information processing system 1 may be configured to include a plurality of apparatuses which are connected to each other via the network N and each of which include at least one selected from the group consisting of the acquisition unit 11, the trajectory candidate generation unit 12, the selection unit 13, the trajectory group generation unit 14, and the output unit 15.

Here, a specific configuration of the network N is not intended to limit the present example embodiment. As an example, it is possible to employ a wireless local area network (LAN), a wired LAN, a wide area network (WAN), a public network, a mobile data communication network, or a combination of these networks.

### (Acquisition Unit 11)

The acquisition unit 11 acquires respective pluralities of pieces of sensor data from a plurality of sensors that detect a position of a target object. The acquisition unit 11 supplies the acquired pluralities of pieces of sensor data to the trajectory candidate generation unit 12 and the selection unit 13.

### (Trajectory Candidate Generation Unit 12)

For each of the plurality of sensors, the trajectory candidate generation unit 12 generates at least one trajectory candidate related to the target object with reference to pieces of sensor data that have been acquired in the past from each of the plurality of sensors and that each indicate a position of the target object. The trajectory candidate generation unit 12 supplies the generated at least one trajectory candidate to the selection unit 13 and the trajectory group generation unit 14.

### (Selection Unit 13)

For each of the plurality of sensors, the selection unit 13 selects, with reference to the at least one trajectory candidate related to the target object, a piece of sensor data indicating the position of the target object from among the pieces of sensor data that have been acquired from each of the plurality of sensors. The selection unit 13 supplies the selected piece of sensor data to the output unit 15.

### (Trajectory Group Generation Unit 14)

The trajectory group generation unit 14 generates a trajectory group of the target object in accordance with a correlation between the trajectory candidates corresponding to respective ones of the plurality of sensors. The trajectory group generation unit 14 supplies the generated trajectory group to the output unit 15.

### (Output Unit 15)

The output unit 15 outputs the selected pieces of sensor data and the trajectory group.

### (Effect of Information Processing System 1)

As described above, the information processing system 1 employs a configuration in which the information processing system 1 includes: the acquisition unit 11 that acquires respective pluralities of pieces of sensor data from a plurality of sensors that detect a position of a target object; the trajectory candidate generation unit 12 that, for each of the plurality of sensors, generates at least one trajectory candidate related to the target object with reference to pieces of sensor data that have been acquired in the past from each of the plurality of sensors and that each indicate a position of the target object; the selection unit 13 that, for each of the plurality of sensors, selects, with reference to the trajectory candidate related to the target object, a piece of sensor data indicating the position of the target object from among the pieces of sensor data that have been acquired from each of the plurality of sensors; the trajectory group generation unit 14 that generates a trajectory group of the target object in accordance with a correlation between the trajectory candidates corresponding to respective ones of the plurality of sensors; and the output unit 15 that outputs the selected pieces of sensor data and the trajectory group.

Thus, according to the information processing system 1, the selected pieces of sensor data and the trajectory group are output. Therefore, it is possible to track the target object with a high degree of accuracy with reference to the selected pieces of sensor data and the trajectory group, in comparison with a case where only either the selected pieces of sensor data or the trajectory group is output. In addition, according to the information processing system 1, the selected pieces of sensor data and the trajectory group are output, instead of all pieces of sensor data and all trajectory candidates. Therefore, it is possible to perform low-load processing for tracking the target object.

### (Flow of Information Processing Method S1)

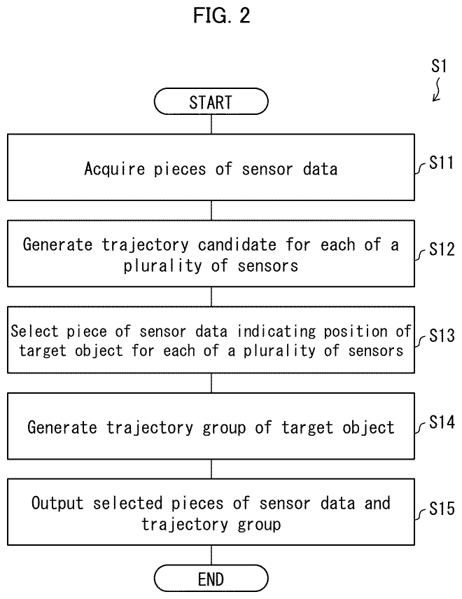

A flow of an information processing method S1 will be described with reference to FIG. 2. FIG. 2 is a flowchart illustrating the flow of the information processing method S1. The information processing method S1 includes an acquisition process S11, a trajectory candidate generation process S12, a selection process S13, a trajectory group generation process S14, and an output process S15, as illustrated in FIG. 2.

### (Acquisition Process S11)

In the acquisition process S11, the acquisition unit 11 acquires respective pluralities of pieces of sensor data from a plurality of sensors that detect a position of a target object. The acquisition unit 11 supplies the acquired pluralities of pieces of sensor data to the trajectory candidate generation unit 12 and the selection unit 13.

### (Trajectory Candidate Generation Process S12)

In the trajectory candidate generation process S12, for each of the plurality of sensors, the trajectory candidate generation unit 12 generates at least one trajectory candidate related to the target object with reference to pieces of sensor data that have been acquired in a past from each of the plurality of sensors and that each indicate a position of the target object. The trajectory candidate generation unit 12 supplies the generated at least one trajectory candidate to the selection unit 13 and the trajectory group generation unit 14.

### (Selection Process S13)

In the selection process S13, for each of the plurality of sensors, the selection unit 13 selects, with reference to the at least one trajectory candidate related to the target object, a piece of sensor data indicating the position of the target object from among the pieces of sensor data that have been acquired from each of the plurality of sensors. The selection unit 13 supplies the selected pieces of sensor data to the output unit 15.

### (Trajectory Group Generation Process S14)

In the trajectory group generation process S14, the trajectory group generation unit 14 generates a trajectory group of the target object in accordance with a correlation between the trajectory candidates corresponding to respective ones of the plurality of sensors. The trajectory group generation unit 14 supplies the generated trajectory group to the output unit 15.

### (Output Process S15)

In the output process S15, the output unit 15 outputs the selected pieces of sensor data and the trajectory group.

### (Effect of Information Processing Method S1)

As described above, the information processing method S1 employs a configuration in which the information includes: the processing method S1 acquisition process S11 in which the acquisition unit 11 acquires respective pluralities of pieces of sensor data from a plurality of sensors that detect a position of a target object; the trajectory candidate generation process S12 in which, for each of the plurality of sensors, the trajectory candidate generation unit 12 generates at least one trajectory candidate related to the target object with reference to pieces of sensor data that have been acquired in the past from each of the plurality of sensors and that each indicate position of the target object; the selection process S13 in which, for each of the plurality of sensors, the selection unit 13 selects, with reference to the trajectory candidate related to the target object, a piece of sensor data indicating the position of the target object from among the pieces of sensor data that have been acquired from each of the plurality of sensors; the trajectory group generation process S14 in which the trajectory group generation unit 14 generates a trajectory group of the target object in accordance with a correlation between respective ones of the trajectory candidates corresponding to respective ones of the plurality of sensors; and the output process S15 in which the output unit 15 outputs the selected pieces of sensor data and the trajectory group.

Thus, according to the information processing method S1, an effect similar to the effect brought about by the above-described information processing system 1 is obtained.

### (Information Processing Apparatus 2)

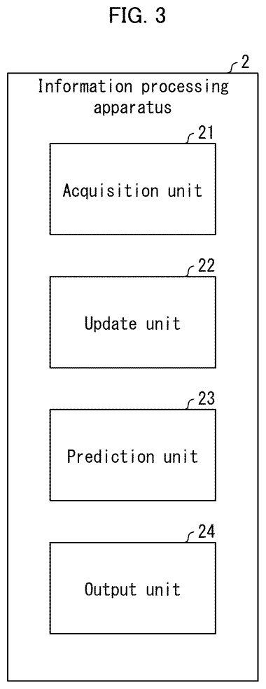

A configuration of an information processing apparatus 2 will be described with reference to FIG. 3. FIG. 3 is a block diagram illustrating the configuration of the information processing apparatus 2.

The information processing apparatus 2 includes an acquisition unit 21, an update unit 22, a prediction unit 23, and an output unit 24, as illustrated in FIG. 3. The acquisition unit 21, the update unit 22, the prediction unit 23, and the output unit 24 realize an acquisition means, an update means, a prediction means, and an output means, respectively, in the present example embodiment.

### (Acquisition Unit 21)

The acquisition unit 21 acquires: pieces of sensor data that have been selected as sensor data indicating a position of a target object from among respective pluralities of pieces of sensor data which have been acquired from a plurality of sensors that detect a position of the target object; and a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object. The acquisition unit 21 supplies the acquired pieces of sensor data and the trajectory group to the update unit 22.

### (Update Unit 22)

The update unit 22 updates a trajectory of the target object with reference to the selected pieces of sensor data and the trajectory group of the target object. The update unit 22 supplies the updated trajectory to the prediction unit 23.

### (Prediction Unit 23)

The prediction unit 23 predicts at least one future trajectory of the target object with reference to the updated trajectory. The prediction unit 23 supplies the predicted trajectory to the output unit 24. The future trajectory of the target object indicates a trajectory that the target object will follow up to a certain point in time in the future.

### (Output Unit 24)

The output unit 24 outputs a predicted consolidation trajectory group, which is the at least one trajectory having been predicted by the prediction unit 23, to an apparatus that selects pieces of sensor data and an apparatus that generates a trajectory group of the target object.

### (Effect of Information Processing Apparatus 2)

As described above, the information processing apparatus 2 employs a configuration in which the information processing apparatus 2 includes: the acquisition unit 21 that acquires: pieces of sensor data that have been selected as sensor data indicating a position of a target object from among respective pluralities of pieces of sensor data which have been acquired from a plurality of sensors that detect a position of the target object; and a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object; the update unit 22 that updates a trajectory of the target object with reference to the selected pieces of sensor data and the trajectory group of the target object; the prediction unit 23 that predicts at least one future trajectory of the target object with reference to the updated trajectory; and the output unit 24 that outputs a predicted consolidation trajectory group, which is the at least one trajectory having been predicted by the prediction unit 23, to an apparatus that selects sensor data and an apparatus that generates a trajectory group of the target object.

Thus, according to the information processing apparatus 2, the trajectory of the target object is updated with reference to the selected pieces of sensor data and the trajectory group. Therefore, it is possible to track the target object with a high degree of accuracy, in comparison with a case where only either the selected pieces of sensor data or the trajectory group is referred to. In addition, according to the information processing apparatus 2, the trajectory of the target object is updated with reference to the selected pieces of sensor data and the trajectory group, instead of all pieces of sensor data and all trajectory candidates. Therefore, it is possible to perform low-load processing for tracking the target object.

In addition, according to the information processing apparatus 2, a predicted consolidation trajectory group, which is at least one predicted trajectory, is output to an apparatus that selects sensor data and an apparatus that generates a trajectory group of the target object. Thus, according to the information processing apparatus 2, a high-accuracy predicted consolidation trajectory group is fed back. Therefore, it is possible to make high-accuracy selection of sensor data and generate a high-accuracy trajectory group of the target object.

### (Flow of Information Processing Method S2)

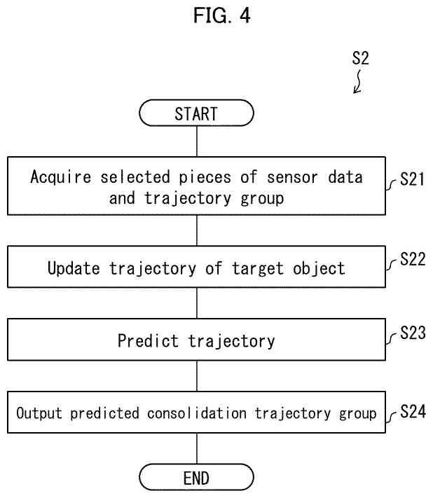

A flow of an information processing method S2 will be described with reference to FIG. 4. FIG. 4 is a flowchart illustrating a flow of the information processing method S2. The information processing method S2 includes an acquisition process S21, an update process S22, a prediction process S23, and an output process S24, as illustrated in FIG. 4.

### (Acquisition Process S21)

In the acquisition process S21, the acquisition unit 21 acquires: pieces of sensor data that have been selected as sensor data indicating a position of a target object from among respective pluralities of pieces of sensor data which have been acquired from a plurality of sensors that detect a position of the target object; and a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object. The acquisition unit 21 supplies the acquired pieces of sensor data and the trajectory group to the update unit 22.

### (Update Process S22)

In the update process S22, the update unit 22 updates a trajectory of the target object with reference to the selected pieces of sensor data and the trajectory group of the target object. The update unit 22 supplies the updated trajectory to the prediction unit 23.

### (Prediction Process S23)

In the prediction process S23, the prediction unit 23 predicts at least one future trajectory of the target object with reference to the updated trajectory. The prediction unit 23 supplies the predicted trajectory to the output unit 24.

### (Output Process S24)

In the output process S24, the output unit 24 outputs a predicted consolidation trajectory group, which is the at least one trajectory having been predicted by the prediction unit 23, to an apparatus that selects sensor data and an apparatus that generates a trajectory group of the target object.

### (Effect of Information Processing Method S2)

As described above, the information processing method S2 employs a configuration in which the information processing method S2 includes: the acquisition process S21 in which the acquisition unit 21 acquires: pieces of sensor data that have been selected as sensor data indicating a position of a target object from among respective pluralities of pieces of sensor data which have been acquired from a plurality of sensors that detect a position of the target object; and a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object; the update process S22 in which the update unit 22 updates a trajectory of the target object with reference to the selected pieces of sensor data and the trajectory group of the target object; the prediction process S23 in which the prediction unit 23 predicts at least one future trajectory of the target object with reference to the updated trajectory; and the output process S24 in which the output unit 24 outputs a predicted consolidation trajectory group, which is the at least one trajectory having been predicted by the prediction unit 23, to an apparatus that selects sensor data and an apparatus that generates a trajectory group of the target object.

Thus, according to the information processing method S2, an effect similar to the effect brought about by the above-described information processing apparatus 2 is obtained.

### (Configuration of Information Processing System 3)

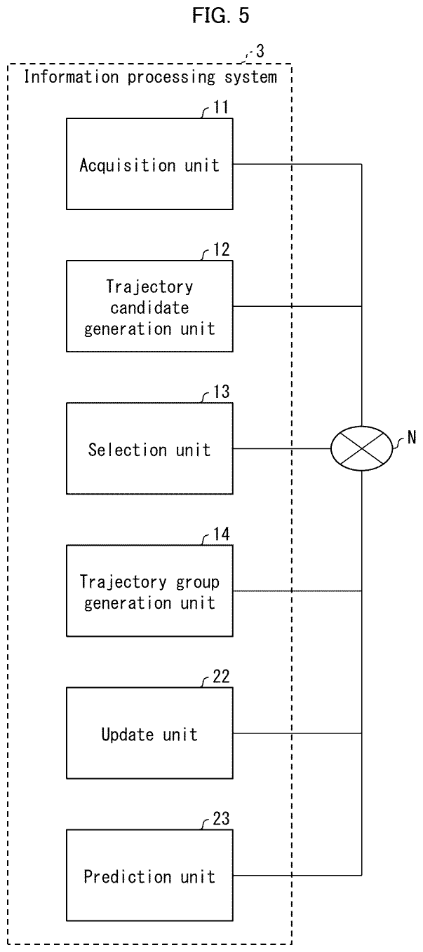

A configuration of an information processing system 3 will be described with reference to FIG. 5. FIG. 5 is a block diagram illustrating the configuration of the information processing system 3.

The information processing system 3 includes an acquisition unit 11, a trajectory candidate generation unit 12, a selection unit 13, a trajectory group generation unit 14, an update unit 22, and a prediction unit 23, as illustrated in FIG. 5. The acquisition unit 11, the trajectory candidate generation unit 12, the selection unit 13, the trajectory group generation unit 14, the update unit 22, and the prediction unit 23 realize an acquisition means, a trajectory candidate generation means, a selection means, a trajectory group generation means, an update means, and a prediction means, respectively, in the present example embodiment.

The acquisition unit 11, the trajectory candidate generation unit 12, the selection unit 13, the trajectory group generation unit 14, the update unit 22, and the prediction unit 23 are connected to a network N so as to be able to transmit and receive to and from each other, as illustrated in FIG. 5. However, the configuration of the information processing system 3 is not limited to such a configuration. The information processing system 3 may be configured such that one apparatus includes the acquisition unit 11, the trajectory candidate generation unit 12, the selection unit 13, the trajectory group generation unit 14, the update unit 22, and the prediction unit 23. Alternatively, the information processing system 3 may be configured to include a plurality of apparatuses which are connected to each other via the network N and each of which include at least one selected from the group consisting of the acquisition unit 11, the trajectory candidate generation unit 12, the selection unit 13, the trajectory group generation unit 14, the update unit 22, and the prediction unit 23. The network N is as described above.

### (Acquisition Unit 11)

The acquisition unit 11 acquires respective pluralities of pieces of sensor data from a plurality of sensors that detect a position of a target object. The acquisition unit 11 supplies the acquired pluralities of pieces of sensor data to the trajectory candidate generation unit 12 and the selection unit 13.

### (Trajectory Candidate Generation Unit 12)

For each of the plurality of sensors, the trajectory candidate generation unit 12 generates at least one trajectory candidate related to the target object with reference to pieces of sensor data that have been acquired in the past from each of the plurality of sensors and that each indicate a position of the target object. The trajectory candidate generation unit 12 supplies the generated at least one trajectory candidate to the selection unit 13 and the trajectory group generation unit 14.

### (Selection Unit 13)

For each of the plurality of sensors, the selection unit 13 selects, with reference to the at least one trajectory candidate related to the target object, a piece of sensor data indicating the position of the target object from among the pieces of sensor data that have been acquired from each of the plurality of sensors. The selection unit 13 supplies the selected piece of sensor data to the update unit 22.

### (Trajectory Group Generation Unit 14)

The trajectory group generation unit 14 generates a trajectory group of the target object in accordance with a correlation between the trajectory candidates corresponding to respective ones of the plurality of sensors. The trajectory group generation unit 14 supplies the generated trajectory group to the update unit 22.

### (Update Unit 22)

The update unit 22 updates a trajectory of the target object with reference to the selected pieces of sensor data and the trajectory group of the target object. The update unit 22 supplies the updated trajectory to the prediction unit 23.

### (Prediction Unit 23)

The prediction unit 23 predicts at least one future trajectory of the target object with reference to the updated trajectory.

### (Effect of Information Processing System 3)

As described above, the information processing system 3 employs a configuration in which the information processing system 3 includes: the acquisition unit 11 that acquires respective pluralities of pieces of sensor data from a plurality of sensors that detect a position of a target object; the trajectory candidate generation unit 12 that, for each of the plurality of sensors, generates at least one trajectory candidate related to the target object with reference to pieces of sensor data that have been acquired in the past from each of the plurality of sensors and that each indicate a position of the target object; the selection unit 13 that, for each of the plurality of sensors, selects, with reference to the trajectory candidate related to the target object, a piece of sensor data indicating the position of the target object from among the pieces of sensor data that have been acquired from each of the plurality of sensors; the trajectory group generation unit 14 that generates a trajectory group of the target object in accordance with a correlation between the trajectory candidates corresponding to respective ones of the plurality of sensors; the update unit 22 that updates a trajectory of the target object with reference to the selected pieces of sensor data and the trajectory group of the target object; and the prediction unit 23 that predicts at least one future trajectory of the target object with reference to the updated trajectory.

Thus, according to the information processing system 3, an effect similar to the effect brought about by the above-described information processing system 1 or the above-described information processing apparatus 2 is obtained.

### (Flow of Information Processing Method S3)

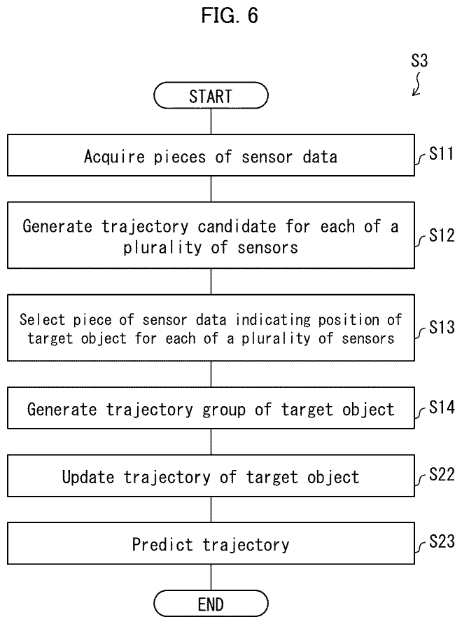

A flow of an information processing method S3 will be described with reference to FIG. 6. FIG. 6 is a flowchart illustrating a flow the information processing method S3. The information processing method S3 includes an acquisition process S11, a trajectory candidate generation process S12, a selection process S13, a trajectory group generation process S14, an update process S22, and a prediction process S23, as illustrated in FIG. 6.

### (Acquisition Process S11)

In the acquisition process S11, the acquisition unit 11 acquires respective pluralities of pieces of sensor data from a plurality of sensors that detect a position of a target object. The acquisition unit 11 supplies the acquired pluralities of pieces of sensor data to the trajectory candidate generation unit 12 and the selection unit 13.

### (Trajectory Candidate Generation Process S12)

In the trajectory candidate generation process S12, for each of the plurality of sensors, the trajectory candidate generation unit 12 generates at least one trajectory candidate related to the target object with reference to pieces of sensor data that have been acquired in a past from each of the plurality of sensors and that each indicate a position of the target object. The trajectory candidate generation unit 12 supplies the generated at least one trajectory candidate to the selection unit 13 and the trajectory group generation unit 14.

### (Selection Process S13)

In the selection process S13, for each of the plurality of sensors, the selection unit 13 selects, with reference to the at least one trajectory candidate related to the target object, a piece of sensor data indicating the position of the target object from among the pieces of sensor data that have been acquired from each of the plurality of sensors. The selection unit 13 supplies the selected piece of sensor data to the update unit 22.

### (Trajectory Group Generation Process S14)

In the trajectory group generation process S14, the trajectory group generation unit 14 generates a trajectory group of the target object in accordance with a correlation between the trajectory candidates corresponding to respective ones of the plurality of sensors. The trajectory group generation unit 14 supplies the generated trajectory group to the update unit 22.

### (Update Process S22)

In the update process S22, the update unit 22 updates a trajectory of the target object with reference to the selected pieces of sensor data and the trajectory group of the target object. The update unit 22 supplies the updated trajectory to the prediction unit 23.

### (Prediction Process S23)

In the prediction process S23, the prediction unit 23 predicts at least one future trajectory of the target object with reference to the updated trajectory.

### (Effect of Information Processing Method S3)

As described above, the information processing method S3 employs a configuration in which the information processing method S3 includes: the acquisition process S11 in which the acquisition unit 11 acquires respective pluralities of pieces of sensor data from a plurality of sensors that detect a position of a target object; the trajectory candidate generation process S12 in which, for each of the plurality of sensors, the trajectory candidate generation unit 12 generates at least one trajectory candidate related to the target object with reference to pieces of sensor data that have been acquired in the past from each of the plurality of sensors and that each indicate a position of the target object; the selection process S13 in which, for each of the plurality of sensors, the selection unit 13 selects, with reference to the trajectory candidate related to the target object, a piece of sensor data indicating the position of the target object from among the pieces of sensor data that have been acquired from each of the plurality of sensors; the trajectory group generation process S14 in which the trajectory group generation unit 14 generates a trajectory group of the target object in accordance with a correlation between the trajectory candidates corresponding to respective ones of the plurality of sensors; the update process S22 in which the update unit 22 updates a trajectory of the target object with reference to the selected pieces of sensor data and the trajectory group of the target object; and the prediction process S23 in which the prediction unit 23 predicts at least one future trajectory of the target object with reference to the updated trajectory.

Thus, according to the information processing method S3, an effect similar to the effect brought about by the above-described information processing system 3 is obtained.

### Second Example Embodiment

A second example embodiment which is an example of an embodiment of the present invention will be described in detail with reference to the drawings. The same reference numerals are given to constituent elements which have functions identical with those described in the above-described example embodiment, and descriptions as such constituent elements are omitted as appropriate. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Overview of Information Processing System 3A)

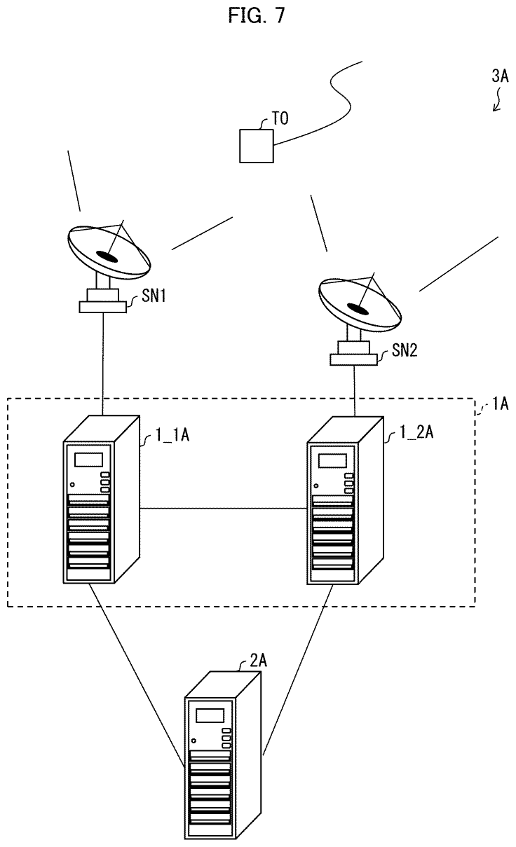

An overview of an information processing system 3A will be described with reference to FIG. 7. FIG. 7 is a view illustrating the overview of the e information processing system 3A.

The information processing system 3A is a system for tracking a target object TO. “Tracking a target object TO” can also be expressed as detecting a consolidation trajectory clc, which is a trajectory of the target object TO. In addition, the information processing system 3A predicts a predicted consolidation trajectory pclc, which is a future trajectory of the target object TO. In the present example embodiment, a case where the consolidation trajectory clc of the target object TO at a time t is detected, and the predicted consolidation trajectory pclc of the target object TO at a time t+1 is predicted will be described as an example.

The target object TO is not particularly limited, provided that the target object TO is a moving object (including a living organism). As an example, the target object TO includes objects moving in the air (e.g., aircrafts (a manned aircraft and an unmanned aircraft)). As another example, the target object TO includes objects (e.g., automobiles) moving on the ground or persons moving on the ground. As still another example, the target object TO includes objects (e.g., ships) moving on water (over the sea). With this configuration, the information processing system 3A can track an object moving in the air, an object moving on the ground, a person moving on the ground, and an object moving on water.

The information processing system 3A includes a plurality of sensors SN, an information processing system 1A, and an information processing apparatus 2A, as illustrated in FIG. 7.

In FIG. 7, the plurality of sensors SN are two sensors which are sensors SN1 and SN2. However, the number of sensors SN is not limited and may be three or more. The plurality of sensors SN may be multiple sensors SN, as illustrated in FIG. 7. Alternatively, a single sensor SN (e.g., a movable sensor SN) capable of changing a sensing range may be employed. Examples of the sensor include, but not limited to, a camera that captures an image, a radar, and a lidar.

In addition, the sensors SN and the information processing system 1A are communicably connected to each other. Further, the information processing system 1A and the information processing apparatus 2A are also communicably connected to each other. The sensors SN and the information processing system 1A may be communicably connected to each other via the above-described network or may be communicatively connected directly to each other. The information processing system 1A and the information processing apparatus 2A may be communicably connected to each other via the above-described network N or may be communicatively connected directly to each other.

Further, the information processing system 1A includes an information processing apparatus 1_1A and an information processing apparatus 1_2A. The information processing apparatus 1_1A and the information processing apparatus 1_2A are also communicatively connected to each other in a similar manner.

The sensor SN1 and the sensor SN2 each detect the position of at least one object that exists in a detection range and output pieces of sensor data sd indicating the position to the information processing system 1A. More specifically, the sensor SN1 outputs the pieces of sensor data sd to the information processing apparatus 1_1A, and the sensor SN2 outputs the pieces of sensor data sd to the information processing apparatus 1_2A.

The information processing system 1A selects pieces of sensor data ssd indicating the position of the target object TO from among the pieces of sensor data sd. In addition, the information processing system 1A generates a trajectory group lcg of the target object TO. The information processing system 1A outputs the selected pieces of sensor data ssd and the trajectory group lcg to the information processing apparatus 2A. The selected pieces of sensor data ssd and the trajectory group lcg will be described later.

The information processing apparatus 2A detects the consolidation trajectory clc of the target object TO by updating the trajectory of the target object TO with reference to the selected pieces of sensor data ssd and the trajectory group lcg. In addition, the information processing apparatus 2A predicts the predicted consolidation trajectory pclc of the target object TO, which is a future trajectory of the target object TO.

Further, the information processing apparatus 2A outputs at least one predicted consolidation trajectory group pclcg, which is obtained by prediction, of the target object TO to the information processing system 1A. The information processing system 1A selects the pieces of sensor data ssd indicating the position of the target object TO with further reference to the predicted consolidation trajectory group pclcg. Thus, the information processing system 3A is a feedback system.

### (Configuration of Information Processing System 1A)

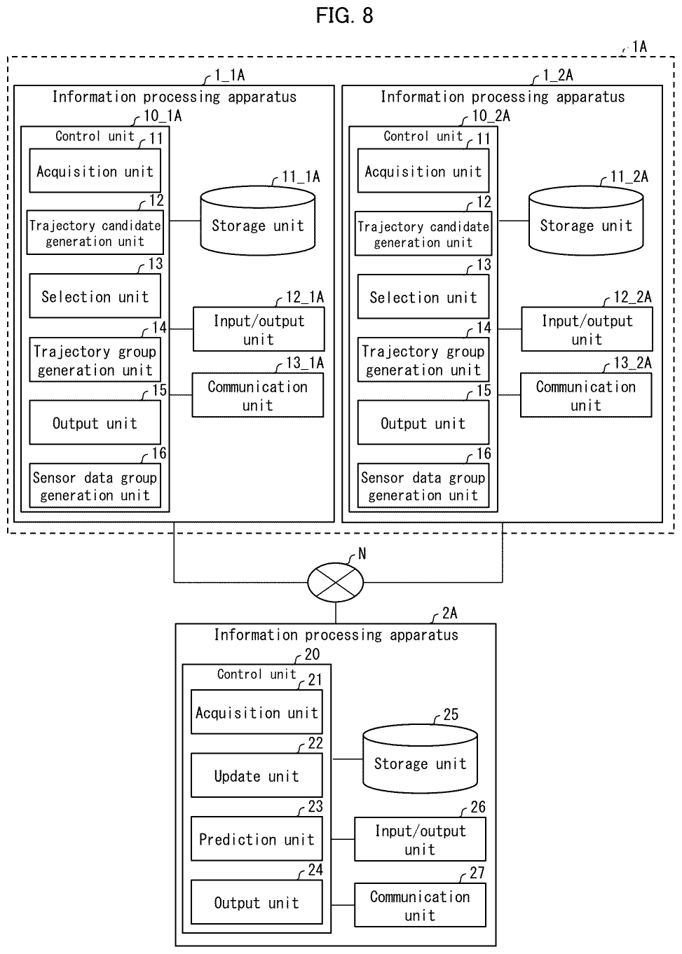

A configuration of the information processing system 1A will be described with reference to FIG. 8. FIG. 8 is a block diagram illustrating configurations of the information processing system 1A and the information processing apparatus 2A.

As described above, the information processing system 1A includes the information processing apparatus 1_1A and the information processing apparatus 1_2A that are capable of communicating with each other. As illustrated in FIG. 8, the information processing apparatus 1_1A and the information processing apparatus 1_2A may have the same functions. Alternatively, the information processing system 1A may be realized by a single information processing apparatus.

In addition, in a case where the information processing apparatus 1_1A and the information processing apparatus 1_2A have the same functions, a configuration may be employed in which another information processing apparatus 1_3A (not illustrated in FIG. 8) capable of communicating with the information processing apparatus 1_1A and the information processing apparatus 1_2A includes one or some of the constituent elements illustrated in FIG. 8. As an example, a configuration may be employed in which a trajectory group generation unit 14, an output unit 15, and a sensor data group generation unit 16, which will be described later, are included in the another information processing apparatus 1_3A, not in the information processing apparatus 1_1A and the information processing apparatus 1_2A.

Alternatively, the information processing apparatus 1_1A and the information processing apparatus 1_2A may have different functions. As an example, a configuration may be employed in which the information processing apparatus 1_1A includes the trajectory group generation unit 14, the output unit 15, and the sensor data group generation unit 16, which will be described later, and the information processing apparatus 1_2A does not include the trajectory group generation unit 14, the output unit 15, and the sensor data group generation unit 16.

In the following description, constituent elements included in the information processing apparatus 1_1A will be described. In the present example embodiment, a case where the information processing apparatus 1_1A and the information processing apparatus 1_2A have the same functions will be described.

The information processing apparatus 1_1A includes a control unit 10_1A, a storage unit 11_1A, an input/output unit 12_1A, and a communication unit 13_1A, as illustrated in FIG. 8.

### (Storage Unit 11_1A)

The storage unit 11_1A stores data to be referred to by the control unit 10_1A. Examples of the storage unit 11_1A include, but not limited to, a flash memory, a hard disk drive (HDD), a solid state drive (SSD), and a combination thereof.

Examples of the data stored in the storage unit 11_1A include, but not limited to, a plurality of pieces of sensor data sd that have been output from the sensor SN1 up to the time t and at least one trajectory candidate lc related to the target object TO.

### (Input/Output Unit 12_1A)

The input/output unit 12_1A is an interface that receives input of data and outputs data. Examples of the input/output unit 12_1A include, but not limited to, a microphone, a camera, a line-of-sight input apparatus, a keyboard, a touch pad, a speaker, and a liquid crystal display.

### (Communication Unit 13_1A)

The communication unit 13_1A is an interface that transmits and receives data via the network N or transmits and receives data directly to and from an apparatus that is capable of communicating with the information processing apparatus 1_1A. Examples of the communication unit 13_1A include, but not limited to, a communication chip in various communication standards such as Ethernet (registered trademark), Wireless Fidelity (Wi-Fi, registered trademark), and radio communications standard for mobile data communications networks, and a USB-compliant connector.

As an example, the communication unit 13_1A receives pieces of sensor data sd from the sensor SN1. As another example, the communication unit 13_1A receives a predicted consolidation trajectory group plclg from the information processing apparatus 2A. As still another example, the communication unit 13_1A transmits a selected piece of sensor data ssd and a trajectory group lcg to the information processing apparatus 2A.

### (Control Unit 10_1A)

The control unit 10_1A controls constituent elements included in the information processing apparatus 1_1A. In addition, the control unit 10_1A includes an acquisition unit 11, a trajectory candidate generation unit 12, a selection unit 13, a trajectory group generation unit 14, an output unit 15, and a sensor data group generation unit 16, as illustrated in FIG. 8. The acquisition unit 11 realizes an acquisition means and a consolidation trajectory group acquisition means in the present example embodiment. The trajectory candidate generation unit 12, the selection unit 13, the trajectory group generation unit 14, the output unit 15, and the sensor data group generation unit 16 realize a trajectory candidate generation means, a selection means, a trajectory group generation means, an output means, and a sensor data group generation means, respectively, in the present example embodiment.

### (Acquisition Unit 11)

The acquisition unit 11 acquires data via the input/output unit 12_1A or the communication unit 13_1A. The acquisition unit 11 stores the acquired data in the storage unit 11_1A. As an example, the acquisition unit 11 acquires pieces of sensor data sd. As another example, the acquisition unit 11 acquires a predicted consolidation trajectory group plclg.

### (Trajectory Candidate Generation Unit 12)

The trajectory candidate generation unit 12 generates at least one trajectory candidate lc related to the target object TO. As an example, the trajectory candidate generation unit 12 generates at least one trajectory candidate lc related to the target object TO at the time t with reference to pieces of sensor data sd that have been acquired in the past from the sensor SN1 (that is, pieces of sensor data sd that have been acquired up to a time t−1) and that indicate a position of the target object TO. The trajectory candidate generation unit 12 stores the generated at least one trajectory candidate lc in the storage unit 11_1A.

As an example of a method by which the trajectory candidate generation unit 12 generates the trajectory candidate lc, a method using a tracking scheme (for example, Multiple Hypothesis Tracking (MHT), Joint Probabilistic Data Association (JPDA), Probability Hypothesis Density (PHD), or Generalized label multi-Bernoulli (GLMB)) in a random finite set is included. As another example of the method by which the trajectory candidate generation unit 12 generates the trajectory candidate lc, a method using ByteTrack in a case where the pieces of sensor data sd are camera images, in addition to the above-described method, is included.

In the information processing system 1A, a process for generating at least one trajectory candidate lc with reference to pieces of sensor data sd is carried out in both the information processing apparatus 1_1A and the information processing apparatus 1_2A. That is, in the information processing system 1A, the process for generating at least one trajectory candidate lc with reference to pieces of sensor data sd is carried out for each of the plurality of sensors SN.

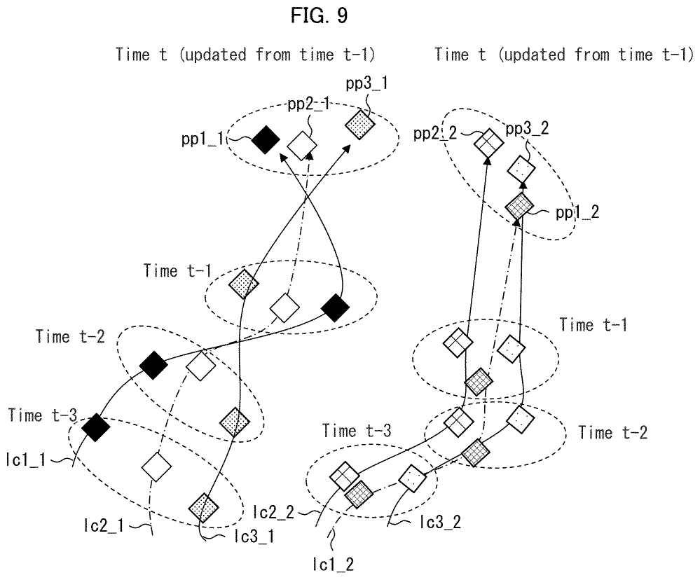

An example of a process carried out by the trajectory candidate generation unit 12 will be described with reference to FIG. 9. FIG. 9 is a view illustrating an example of the trajectory candidate lc.

The trajectory candidate generation unit 12 of the information processing apparatus 1_1A generates a trajectory candidate lc1_1 and a trajectory candidate lc1_2 which are illustrated in FIG. 9 by predicting positions (position pp1_1 and position pp1_2) of the target object TO at a time t with reference to pieces of sensor data sd up to a time t−1.

Similarly, the trajectory candidate generation unit 12 of the information processing apparatus 1_2A generates a trajectory candidate lc2_1 and a trajectory candidate lc2_2 which are illustrated in FIG. 9.

A trajectory candidate lc3_1 and a trajectory candidate lc3_2 which are illustrated in FIG. 9 are trajectory candidates lc that are included in a predicted consolidation trajectory group plclg which has been generated by the information processing apparatus 2A. The trajectory candidate lc3_1 and the trajectory candidate lc3_2 will be described later.

### (Selection Unit 13)

The selection unit 13 selects a piece of sensor data ssd indicating the position of the target object TO from among pieces of sensor data sd. As an example, the selection unit 13 selects a piece of sensor data ssd indicating the position of the target object TO from among pieces of sensor data sd that have been acquired from the sensor SN1 at the time t, with reference to the trajectory candidate lc related to the target object TO at the time t that has been generated by the trajectory candidate generation unit 12. The selection unit 13 stores the selected piece of sensor data ssd in the storage unit 11_1A.

In the information processing system 1A, a process for selecting a piece of sensor data ssd indicating the position of the target object TO is carried out in both the information processing apparatus 1_1A and the information processing apparatus 1_2A. That is, in the information processing system 1A, the process for selecting a piece of sensor data ssd indicating the position of the target object TO is carried out for each of the plurality of sensors SN.

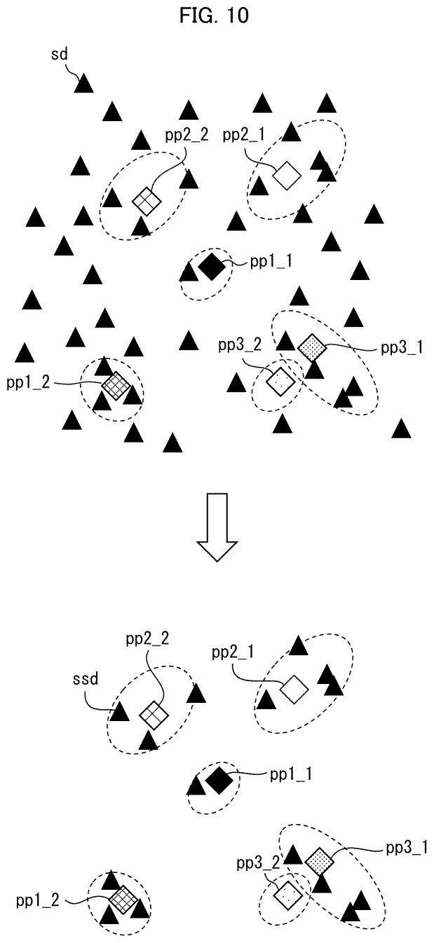

An example of a process carried out by the selection unit 13 will be described with reference to FIG. 10. FIG. 10 is a view illustrating an example of the sensor data sd and the selected sensor data ssd.

As illustrated in an upper part of FIG. 10, the pieces of sensor data sd that have been acquired from the sensor SN1 at the time t include, in addition to a piece of sensor data sd indicating the position of the target object TO, a piece of sensor data sd indicating the position of another object. In the following description, the piece of sensor data sd indicating the position of another object is also referred to as noise.

First, as illustrated in an upper part of FIG. 10, the selection unit 13 compares the pieces of sensor data sd that have been acquired from the sensor SN1 at the time t with a position pp of the target object TO at the time t that has been specified with reference to a trajectory candidate lc related to the target object TO at the time t that has been generated by the trajectory candidate generation unit 12.

Next, as illustrated in a lower part of FIG. 10, the selection unit 13 selects a piece of sensor data ssd around the position pp of the target object TO at a time t from among the pieces of sensor data sd. In other words, the selection unit 13 selects at least one piece of sensor data ssd indicating a position that is estimated to be the position of the target object TO at the time t from among the pieces of sensor data sd.

Here, the selection unit 13 of the information processing apparatus 1_1A may be configured to refer to only the trajectory candidate lc1_1 and the trajectory candidate lc1_2, which have been generated by the trajectory candidate generation unit 12 of the information processing apparatus 1_1A. Alternatively, the selection unit 13 of the information processing apparatus 1_1A may be configured to acquire the trajectory candidate lc2_1 and the trajectory candidate lc2_2, which have been generated by the trajectory candidate generation unit 12 of the information processing apparatus 1_2A, and refer to the trajectory candidate lc2_1 and the trajectory candidate lc2_2, in addition to the trajectory candidate lc1_1 and the trajectory candidate lc1_2.

For example, in the drawing illustrated in the upper part of FIG. 10, the selection unit 13 specifies a position pp1_1 and a position pp1_2 of the target object TO at the time t with reference to the trajectory candidate lc1_1 and the trajectory candidate lc1_2, which have been generated by the trajectory candidate generation unit 12 of the information processing apparatus 1_1A. Then, in the drawing illustrated in the lower part of FIG. 10, the selection unit 13 selects pieces of sensor data ssd around each of the positions pp1_1 and pp1_2.

Alternatively, in the drawing illustrated in the upper part of FIG. 10, the selection unit 13 specifies, in addition to the position pp1_1 and the position pp1_2, a position pp2_1 and a position pp2_2 of the target object TO at the time t with reference to the trajectory candidate lc2_1 and the trajectory candidate lc2_2, which have been generated by the trajectory candidate generation unit 12 of the information processing apparatus 1_2A. Then, in the drawing illustrated in the lower part of FIG. 10, the selection unit 13 selects pieces of sensor data ssd around each of the positions pp1_1, pp1_2, pp2_1, and pp2_2.

Note that, in FIG. 10, the positions pp3_1 and pp3_2 are positions that are specified by the trajectory candidate lc which is included in the predicted consolidation trajectory group pclcg. The position pp3_1 and the position pp3_2 will be described later.

In addition, with regard to a range for selecting a piece of sensor data ssd, as an example, the selection unit 13 may select a piece of sensor data ssd that is within a predetermined range from the position pp of the target object TO at the time t.

As another example, the selection unit 13 may select a piece of sensor data ssd indicating the position of the target object TO in accordance with the degree of distribution of pieces of sensor data sd that are present around the position pp of the target object TO. In other words, the selection unit 13 sets a range for selecting a piece of sensor data ssd in accordance with the position pp of the target object TO, the number of the pieces of sensor data sd that are present around the position pp, and a distance between the pieces of sensor data sd and the position pp.

For example, in the drawing illustrated in the upper part of FIG. 10, around the position pp1_1 of the target object TO at the time t, only one piece of sensor data sd is present at a short distance from the position pp1_1. Thus, for the position pp1_1 of the target object TO at the time t, the selection unit 13 narrows the range for selecting a piece of sensor data ssd. Meanwhile, in the drawing illustrated in the upper part of FIG. 10, around the position pp2_1 of the target object TO at the time t, four pieces of sensor data sd are present at a slightly short distance from the position pp2_1. Thus, for the position pp2_1 of the target object TO at the time t, the selection unit 13 widens the range for selecting a piece of sensor data ssd.

With this configuration, in a case where the reliability of the sensor data ssd indicating the position of the target object TO is low, the selection unit 13 can select many pieces of sensor data ssd as candidates.

As still another example, the selection unit 13 may change the range for selecting a piece of sensor data ssd in accordance with the position pp of the target object TO. For example, in a case where the position pp is a place where there are many noises, the selection unit 13 sets the range for selecting a piece of sensor data ssd to be a wide range. As yet another example, the range for selecting a piece of sensor data ssd may be changed depending on a sensor SN. For example, in a case where there is a sensor SN that detects many noises, the selection unit 13 sets the range for selecting a piece of sensor data ssd to be a wide range, with regard to pieces of sensor data sd that have been acquired from the sensor SN.

Further, the selection unit 13 may limit the number of pieces of sensor data ssd to be selected. For example, the selection unit 13 may set an upper limit of a total number of pieces of sensor data ssd to be selected from among pieces of sensor data sd at the time t, or the selection unit 13 may set the upper limit of the total number of pieces of sensor data ssd to be selected, for each position pp that has been specified from a trajectory candidate lc. In this configuration, the selection unit 13 may select the pieces of sensor data ssd up to a limited number in the order of decreasing proximity to the position pp.

### (Trajectory Group Generation Unit 14)

The trajectory group generation unit 14 generates a trajectory group lcg of the target object TO. As an example, the trajectory group generation unit 14 generates the trajectory group lcg in accordance with a correlation between the trajectory candidate lc that has been generated by the trajectory candidate generation unit 12 of the information processing apparatus 1_1A and the trajectory candidate lc that has been generated by the trajectory candidate generation unit 12 of the information processing apparatus 1_2A. The trajectory group generation unit 14 stores the generated trajectory group lcg in the storage unit 11_1A.

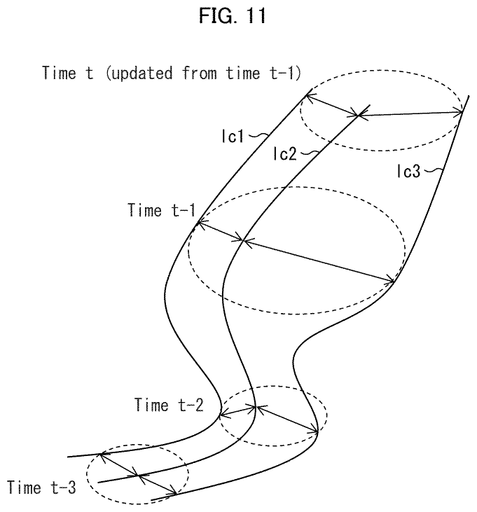

An example of a process for the trajectory group generation unit 14 generating the trajectory group lcg will be described with reference to FIG. 11. FIG. 11 is a view illustrating an example of the trajectory group lcg.

As illustrated in FIG. 11, the trajectory group generation unit 14 compares the trajectory candidate lc1, which has been generated by the trajectory candidate generation unit 12 of the information processing apparatus 1_1A, with the trajectory candidate lc2, which has been generated by the trajectory candidate generation unit 12 of the information processing apparatus 1_2A. As an example, the trajectory group generation unit 14 generates a trajectory group lcg that includes a plurality of trajectory candidates lc which have a high degree of similarity among degrees of similarities between the trajectory candidates lc1 and lc2 corresponding to respective ones of the plurality of sensors SN. In other words, the trajectory group generation unit 14 determines whether or not the degree of similarity (degree of coincidence) between the trajectory candidate lc1 and the trajectory candidate lc2 is high.

As an example of a method for the trajectory group generation unit 14 determining whether or not the degree of similarity between trajectory candidates is high, a configuration in which a distance between trajectory candidates lc is referred to is included. For example, the trajectory group generation unit 14 determines whether or not a distance between any plurality of points on the trajectory candidate lc1 and any plurality of points on the trajectory candidate lc2 at a time that is the same as a time corresponding to each of the plurality of points on the trajectory candidate lc1 is shorter than a predetermined distance.

For example, as illustrated in FIG. 11, the trajectory group generation unit 14 calculates a distance between a point on the trajectory candidate lc1 and a point on the trajectory candidate lc2 at a time t−3, a distance between a point on the trajectory candidate lc1 and a point on the trajectory candidate lc2 at a time t−2, a distance between a point on the trajectory candidate lc1 and a point on the trajectory candidate lc2 at a time t−1, and a distance between a point on the trajectory candidate lc1 and a point on the trajectory candidate lc2 at the time t. Then, in a case where each of the calculated distances is shorter than a predetermined distance, the trajectory group generation unit 14 generates a trajectory group lcg that includes the trajectory candidate lc1 and the trajectory candidate lc2.

On the other hand, in FIG. 11, in a case where the trajectory candidate generation unit 12 of the information processing apparatus 1_1A has generated the trajectory candidate lc3, a distance between a point at the same time on the trajectory candidate lc2, which has been generated by the trajectory candidate generation unit 12 of the information processing apparatus 1_2A, and a point at the same time on the trajectory candidate lc3, which has been generated by the trajectory candidate generation unit 12 of the information processing apparatus 1_1A, becomes long. Thus, the trajectory group generation unit 14 does not include the trajectory candidate lc3 in the trajectory group lcg.

With this configuration, the trajectory group generation unit 14 can suitably generate the trajectory group lcg that includes a plurality of trajectory candidates lc between which there is a high correlation.

As another example, the trajectory group generation unit 14 may be configured to refer to the selected pieces of sensor data ssd, in addition to carrying out the process illustrated in FIG. 11. As an example, the trajectory group generation unit 14 may generate the trajectory group lcg of the target object TO in accordance with a correlation between the selected pieces of sensor data ssd corresponding to the respective ones of the plurality of sensors SN.

For example, in addition to carrying out the process illustrated in FIG. 11, the trajectory group generation unit 14 determines whether or not the degree of similarity (degree of coincidence) between the sensor data ssd at the time t that has been selected by the selection unit 13 of the information processing apparatus 1_1A and the sensor data ssd at the time t that has been selected by the selection unit 13 of the information processing apparatus 1_2A is high. As an example, the trajectory group generation unit 14 determines whether or not a distance between the sensor data ssd at the time t that has been selected by the selection unit 13 of the information processing apparatus 1_1A and the sensor data ssd at the time t that has been selected by the selection unit 13 of the information processing apparatus 1_2A is shorter than a predetermined distance.

In the trajectory candidate lc1 and the trajectory candidate lc2 which have a high degree of similarity among degrees of similarity between the trajectory candidates, in a case where it has also been determined that the distance between the pieces of sensor data ssd is shorter than the predetermined distance, the trajectory group generation unit 14 generates the trajectory group lcg that includes the trajectory candidate lc1 and the trajectory candidate lc2. On the other hand, in a case where it has been determined that the distance between the pieces of the sensor data ssd is equal to or longer than the predetermined distance, the trajectory group generation unit 14 does not generate the trajectory group lcg that includes the trajectory candidate lc1 and the trajectory candidate lc2.

With this configuration, the trajectory group generation unit 14 can accurately determine whether or not a correlation between the trajectory candidates is high (whether or not the degree of similarity or the degree of coincidence is high).

### (Output Unit 15)

The output unit 15 outputs data via the communication unit 13_1A or to the input/output unit 12_1A. As an example, the output unit 15 outputs the selected pieces of sensor data ssd and the trajectory group lcg to the information processing apparatus 2A via the communication unit 13_1A.

As an example, the output unit 15 outputs the selected pieces of sensor data ssd and trajectory candidates lc which are included in the trajectory group lcg and which correspond to respective ones of the selected pieces of sensor data ssd in such a manner that the selected pieces of sensor data ssd and the corresponding trajectory candidates lc included in the trajectory group lcg are associated with each other. For example, in a case where the trajectory group lc1_1 and the trajectory candidate lc2_1 are included in the trajectory group lcg, the output unit 15 outputs the pieces of sensor data ssd and the trajectory group lcg to the information processing apparatus 2A in such a manner that, in the drawing illustrated in FIG. 10, the trajectory candidate lc1_1 and the sensor data ssd around the position pp1_1 at the time t of the trajectory candidate lc1_1 are associated with each other, and the trajectory candidate lc2_1 and the sensor data ssd around the position pp2_1 at the time t of the trajectory candidate lc2_1 are associated with each other. With this configuration, the output unit 15 can facilitate detection of a consolidation trajectory clc in the information processing apparatus 2A which will be described later.

As another example, the output unit 15 outputs, to the information processing apparatus 2A, the trajectory group lcg and a sensor data group ssdg that has been generated by the sensor data group generation unit 16 which will be described later.

### (Sensor Data Group Generation Unit 16)

The sensor data group generation unit 16 generates the sensor data group ssdg. As an example, the sensor data group generation unit 16 generates the sensor data group ssdg in accordance with a correlation between the pieces of sensor data ssd that have been selected by the selection unit 13 and that correspond to the respective ones of the plurality of sensors SN. Further, as described above, the sensor data group ssdg generated by the sensor data group generation unit 16 is output together with the trajectory group lcg by the output unit 15.

For example, assumed are sensor data ssd1 that is selected from among pieces of sensor data sd at the time t which have been acquired from the sensor SN1 and sensor data ssd2 that is selected from among pieces of sensor data sd at the time t which have been acquired from the sensor SN2.

In this case, the sensor data group generation unit 16 determines a correlation between the sensor data ssd1 and the sensor data ssd2. As an example, the sensor data group generation unit 16 calculates a distance between a position indicated by the sensor data ssd1 and a position indicated by the sensor data ssd2. In a case where the distance is shorter than a predetermined distance, the sensor data group generation unit 16 generates a sensor data group ssdg that includes the sensor data ssd1 and the sensor data ssd2. On the other hand, in a case where the distance is equal to or longer than the predetermined distance, the sensor data group generation unit 16 does not generate the sensor data group ssdg that includes the sensor data ssd1 and the sensor data ssd2.

With this configuration, the sensor data group generation unit 16 generates the sensor data group ssdg that includes pieces of sensor data ssd between which there is a high correlation. Therefore, it is possible to facilitate detection of a consolidation trajectory clc in the information processing apparatus 2A.

### (Configuration of Information Processing Apparatus 2A)

A configuration of the information processing apparatus 2A will be described with reference to FIG. 8 again. The information processing apparatus 2A includes a control unit 20, a storage unit 25, an input/output unit 26, and a communication unit 27, as illustrated in FIG. 8.

### (Storage Unit 25)

The storage unit 25 stores data to be referred to by the control unit 20. Examples of the storage unit 25 include, but not limited to, a flash memory, an HDD, an SSD, and a combination of these.

Examples of the data stored in the storage unit 25 include, but not limited to, the selected pieces of sensor data ssd, the trajectory group lcg, the updated consolidation trajectory clc, and the predicted consolidation trajectory pclc, which is obtained by prediction, of the target object TO.

### (Input/Output Unit 26)

The input/output unit 26 is an interface that receives input of data and outputs data. Examples of the input/output unit 26 include, but not limited to, a microphone, a camera, a line-of-sight input apparatus, a keyboard, a touch pad, a speaker, and a liquid crystal display.

### (Communication Unit 27)

The communication unit 27 is an interface that transmits and receives data via the network N or transmits and receives data directly to and from an apparatus that is capable of communicating with the information processing apparatus 2A. Examples of the communication unit 27 include, but are not limited to, a communication chip in various communication standards such as Ethernet, Wi-Fi, and radio communications standard for mobile data communications networks, and a USB-compliant connector.

As an example, the communication unit 27 receives the selected pieces of sensor data ssd and the trajectory group lcg from the information processing system 1A. As another example, the communication unit 27 receives the sensor data group ssdg and the trajectory group lcg from the information processing system 1A. As still another example, the communication unit 27 transmits, to the information processing system 1A, the predicted consolidation trajectory group plclg which will be described later.

### (Control Unit 20)

The control unit 20 controls constituent elements included in the information processing apparatus 2A. In addition, the control unit 20 includes an acquisition unit 21, an update unit 22, a prediction unit 23, and an output unit 24, as illustrated in FIG. 8. The acquisition unit 21, the update unit 22, the prediction unit 23, and the output unit 24 realize an acquisition means, an update means, a prediction means, and an output means, respectively, in the present example embodiment.

### (Acquisition Unit 21)

The acquisition unit 21 acquires data via the input/output unit 26 or the communication unit 27. The acquisition unit 21 stores the acquired data in the storage unit 25. As an example, the acquisition unit 21 acquires the selected pieces of sensor data ssd and the trajectory group lcg. As another example, the acquisition unit 21 acquires the sensor data group ssdg and the trajectory group lcg.

### (Update Unit 22)

The update unit 22 updates the trajectory of the target object TO. As an example, the update unit 22 updates the trajectory of the target object TO with reference to the pieces of sensor data ssd (or the sensor data group ssdg) and the trajectory group lcg that have been acquired by the acquisition unit 21. The trajectory that has been updated by the update unit 22 is also referred to as consolidation trajectory clc. The process carried out by the update unit 22 corresponds to an update step in a Kalman filter.

As an example, the update unit 22 updates the consolidation trajectory clc at the time t−1 to the consolidation trajectory clc at the time t with reference to the positions indicated by the pieces of sensor data ssd at the time t and the trajectory candidates lc that are included in the trajectory group lcg at the time t and that are associated with the pieces of sensor data ssd. As another example, the update unit 22 updates the consolidation trajectory clc at the time t−1 to the consolidation trajectory clc at the time t with reference to the sensor data group ssdg and the trajectory group lcg.

Here, even in a case where the pieces of sensor data ssd to be referred to by the update unit 22 contain a noise, and the trajectory group lcg includes a wrong trajectory candidate lc, the pieces of sensor data ssd to be referred to by the update unit 22 also contain sensor data ssd other than the noise, and the trajectory group lcg also includes a correct trajectory candidate lc. Thus, the update unit 22 can generate a high-accuracy consolidation trajectory clc.

In addition, in a case where there are a plurality of consolidation trajectories clc at the time t−1, the update unit 22 updates respective ones of the plurality of consolidation trajectories clc to consolidation trajectories clc at the time t. In other words, the update unit 22 updates at least one consolidation trajectory clc at the time t−1 respectively to at least one consolidation trajectory clc at the time t.

### (Prediction Unit 23)

The prediction unit 23 predicts at least one consolidation trajectory clc of the target object TO at a time t+1. As an example, the prediction unit 23 predicts at least one consolidation trajectory clc of the target object TO at the time t+1 with reference to at least one consolidation trajectory clc at the time t that has been obtained by update by the update unit 22. The consolidation trajectory clc at the time t+1 that has been obtained by the prediction is also referred to as predicted consolidation trajectory pclc at the time t+1.

As an example, the prediction unit 23 predicts at least one predicted consolidation trajectory pclc of the target object TO at the time t+1 with use of a prediction model that uses a trajectory at the time t as input and predicts a trajectory at the time t+1.

As an example, the prediction unit 23 predicts at least one predicted consolidation trajectory pclc of the target object TO at the time t+1 with use of a prediction model that predicts a trajectory at the time t+1 in a case where a motion of the target object TO is a uniform linear motion or a uniform accelerated motion. The prediction model in this case may be a model in which air resistance is taken into consideration (a model in which a parameter of air resistance is set).

As another example, the prediction unit 23 predicts at least one predicted consolidation trajectory pclc of the target object TO at the time t+1 with use of a prediction model that has been generated by machine learning.

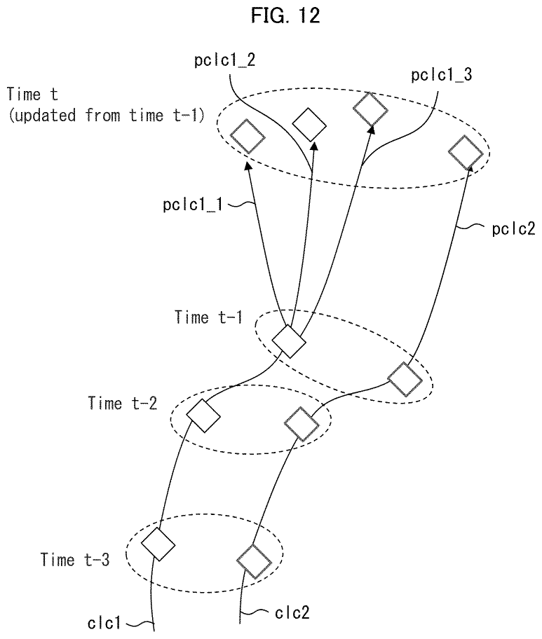

An example of a process carried out by the prediction unit 23 will be described with reference to FIG. 12. FIG. 12 is a view illustrating an example of the predicted consolidation trajectory pclc.

The prediction unit 23 predicts at least one predicted consolidation trajectory pclc with reference to a consolidation trajectory clc1 up to the time t. For example, as illustrated in FIG. 12, with reference to the consolidation trajectory clc1 up to the time t, the prediction unit 23 predicts at least one predicted consolidation trajectory pclc1_1 of the target object TO at the time t+1 with use of a prediction model that predicts a trajectory at the time t+1 in a case where a motion of the target object TO is a uniform linear motion or a uniform accelerated motion.

Further, as illustrated in FIG. 12, the prediction unit 23 changes a parameter setting of the prediction model in which the predicted consolidation trajectory pclc1 has been predicted (for example, changes a parameter of air resistance) and predicts at least one predicted consolidation trajectory pclc1_2 of the target object TO at the time t+1 with use of a prediction model obtained by the change.

Further, the prediction unit 23 predicts at least one predicted consolidation trajectory pclc1_3 of the target object TO at the time t+1 with use of a prediction model that has been generated by machine learning.

Similarly, for the consolidation trajectory clc2 up to the time t, the prediction unit 23 predicts at least one predicted consolidation trajectory pclc2 of the target object TO at the time t+1.

### (Output Unit 24)

The output unit 24 outputs data via the communication unit 27 or to the input/output unit 26. As an example, the output unit 24 outputs, to the information processing system 1A, a predicted consolidation trajectory group pclcg that includes at least one predicted consolidation trajectory pclc which has been obtained by prediction by the prediction unit 23. As another example, the output unit 24 outputs, to the input/output unit 26, an image that includes a consolidation trajectory clc which has been obtained by update by the update unit 22 and at least one predicted consolidation trajectory pclc which has been predicted by the prediction unit 23.

### (Processes Carried Out in Information Processing System 3A)

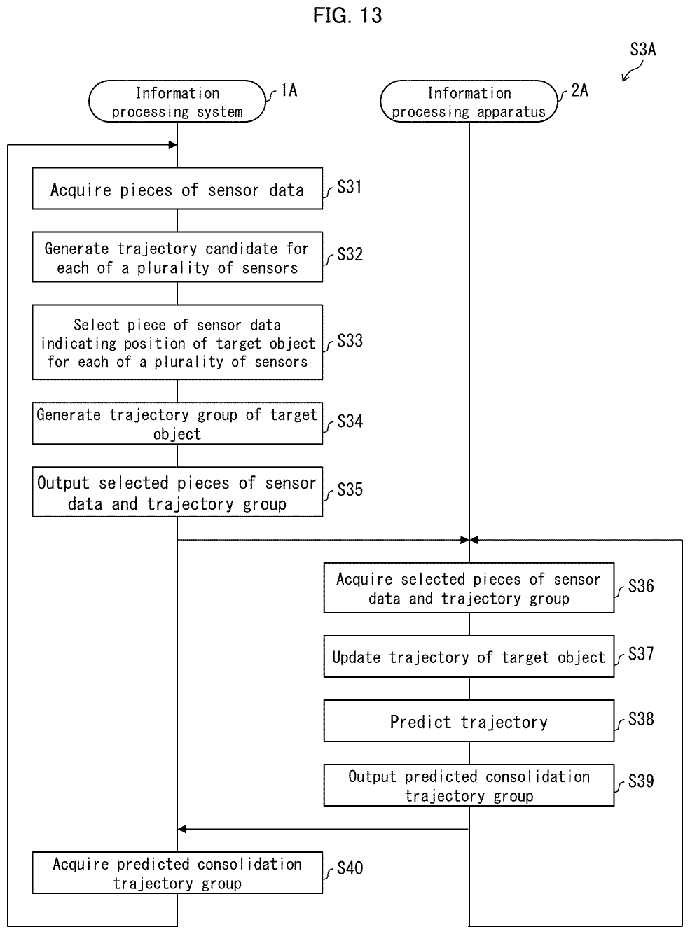

A flow (S3A) of processes carried out in the information processing system 3A will be described with reference to FIG. 13. FIG. 13 is a sequence diagram illustrating a flow of processes that are carried out in the information processing system 3A. The following processes are processes that are carried out after the acquisition unit 11 of the information processing system 1A has acquired pieces of sensor data sd up to the time t−1.

### (Step S31)

In step S31, the acquisition unit 11 of the information processing system 1A acquires pieces of sensor data sd at a time t. The acquisition unit 11 stores the acquired pieces of sensor data sd in the storage unit 11_1A.

### (Step S32)

In step S32, the trajectory candidate generation unit 12 generates at least one trajectory candidate lc related to the target object TO at a time t with reference to pieces of sensor data sd that are pieces of sensor data sd up to a time t−1 and that indicate the position of the target object TO. The trajectory candidate generation unit 12 stores the generated at least one trajectory candidate lc in the storage unit 11_1A.

### (Step S33)

In step S33, the selection unit 13 selects a piece of sensor data ssd indicating the position of the target object TO from among pieces of sensor data sd at the time t that have been acquired from the sensor SN1, with reference to the trajectory candidate lc related to the target object TO that has been generated by the trajectory candidate generation unit 12. The selection unit 13 stores the selected piece of sensor data ssd in the storage unit 11_1A.

### (Step S34)

In step S34, the trajectory group generation unit 14 generates a trajectory group lcg in accordance with a correlation between the trajectory candidates lc corresponding to respective ones of the plurality of sensors SN. The trajectory group generation unit 14 stores the generated trajectory group lcg in the storage unit 11_1A.

### (Step S35)

In step S35, the output unit 15 outputs, to the information processing apparatus 2A, the selected pieces of sensor data ssd and the trajectory candidates lc which are included in the trajectory group lcg and which correspond to respective ones of the pieces of sensor data ssd in such a manner that the selected pieces of sensor data ssd and the corresponding trajectory candidates lc included in the trajectory group lcg are associated with each other. Alternatively, the sensor data group generation unit 16 generates a sensor data group ssdg, and the output unit 15 outputs, to the information processing apparatus 2A, the trajectory group lcg and the sensor data group ssdg that has been generated by the sensor data group generation unit 16.

### (Step S36)

The acquisition unit 21 of the information processing apparatus 2A acquires the selected pieces of sensor data ssd and the trajectory group lcg. Alternatively, the acquisition unit 21 acquires the sensor data group ssdg and the trajectory group lcg. The acquisition unit 21 stores, in the storage unit 25, (i) the acquired pieces of sensor data ssd or the sensor data group ssdg and (ii) the trajectory group lcg.

### (Step S37)

The update unit 22 updates the trajectory of the target object TO with reference to the pieces of sensor data ssd (or the sensor data group ssdg) and the trajectory group lcg that have been acquired by the acquisition unit 21 to generate at least one consolidation trajectory clc at the time t. The update unit 22 stores the generated at least one consolidation trajectory clc in the storage unit 25.

### (Step S38)

In step S38, the prediction unit 23 predicts at least one consolidation trajectory clc of the target object TO at the time t+1 with reference to the at least one consolidation trajectory clc at the time t that has been obtained by update by the update unit 22 to generate a predicted consolidation trajectory pclc. The prediction unit 23 stores the generated predicted consolidation trajectory pclc in the storage unit 25.

### (Step S39)

In step S39, the output unit 24 outputs, to the information processing system 1A, a predicted consolidation trajectory group pclcg that includes at least one predicted consolidation trajectory pclc which has been obtained by prediction by the prediction unit 23.

### (Step S40)

In step S40, the acquisition unit 11 of the information processing system 1A acquires the predicted consolidation trajectory group plclg. In other words, the acquisition unit 11 acquires the predicted consolidation trajectory group that includes the predicted consolidation trajectory pclc (predicted consolidation trajectory pclc at the time t+1) which is at least one trajectory of the target object TO predicted with reference to the pieces of sensor data ssd and the trajectory group lcg (the pieces of sensor data ssd and the trajectory group lcg at the time t) both of which have been output in the past by the output unit 15. The acquisition unit 11 stores the acquired predicted consolidation trajectory group plclg in the storage unit 11_1A.

(Processes after Step S40)

After the process in step S40 has been carried out, the information processing system 1A carries out the processes in step S31 and in the following steps again.

In step S31, the acquisition unit 11 acquires pieces of sensor data sd at the time t+1.

In step S32, the trajectory candidate generation unit 12 includes the at least one predicted consolidation trajectory pclc at the time t+1, which is included in the predicted consolidation trajectory group plclg, in at least one trajectory candidate lc related to the target object TO at the time t+1. For example, as illustrated in FIG. 9, the trajectory candidate generation unit 12 sets, as the trajectory candidate lc3_1 and the trajectory candidate lc3_2, the predicted consolidation trajectory pclc1 and the predicted consolidation trajectory pclc2 which are included in the predicted consolidation trajectory group plclg.

In step S33, the selection unit 13 selects pieces of sensor data ssd indicating the position of the target object TO from among the pieces of sensor data sd that have been acquired from the sensor SN1 at the time t+1, with further reference to the predicted consolidation trajectories pclc. For example, as illustrated in FIG. 10, the selection unit 13 specifies the position pp3_1 and the position pp3_2 with reference to the trajectory candidate lc3_1 and the trajectory candidate lc3_2. In addition, the selection unit 13 selects pieces of sensor data ssd around each of the positions pp3_1 and pp3_2.

Next, in step S34, the trajectory group generation unit 14 generates a trajectory group lcg in accordance with a correlation between the trajectory candidates lc that include the trajectory candidate lc3_1 and the trajectory candidate lc3_2. Steps S35 and S36 are as described above.

Subsequently, in step S37, the update unit 22 generates a consolidation trajectory clc with reference to the pieces of sensor data ssd and the trajectory group lcg. Then, in step S37, the prediction unit 23 generates a predicted consolidation trajectory pclc at a time t+2 with reference to the generated consolidation trajectory clc.

That is, in the information processing system 3A, the predicted consolidation trajectory pclc at the time t+1 is generated with reference to the trajectory candidates lc at the time t. Then, with reference to the predicted consolidation trajectory pclc at the time t+1 in addition to the trajectory candidates lc that are generated with reference to the pieces of sensor data sd at the time t+1, the predicted consolidation trajectory pclc at the time t+2 is generated.

Thus, in the information processing system 3A, the high-accuracy predicted consolidation trajectory pclc generated with reference to the high-accuracy consolidation trajectory clc is fed back to the information processing system 1A. Therefore, it is possible to select the sensor data ssd with a higher degree of accuracy and generate the trajectory group lcg with a higher degree of accuracy. In addition, the consolidation trajectory clc is generated with reference to the high-accuracy pieces of sensor data ssd and the high-accuracy trajectory group lcg. Thus, in the information processing system 3A, it is possible to track the target object TO with a high degree of accuracy.

### (Effect of Information Processing System 3A)

In the information processing system 3A, the information processing system 1A outputs, to the information processing apparatus 2A, the selected pieces of sensor data ssd and the trajectory group lcg that includes the trajectory candidates lc based on the correlation among the generated at least one trajectory candidate lc. The information processing apparatus 2A generates the at least one consolidation trajectory clc with reference to the selected pieces of sensor data ssd and the trajectory group lcg.

Thus, in the information processing system 3A, the information processing apparatus 2A generates the at least one consolidation trajectory clc with reference to both the pieces of sensor data ssd and the trajectory group lcg. Thus, even if the pieces of sensor data ssd contain a noise, and the trajectory group lcg contains a wrong trajectory candidate lc, corrections are possible. Therefore, in the information processing system 3A, it is possible to track the target object with a high degree of accuracy.

Further, in the information processing system 3A, instead of outputting all of the pieces of sensor data sd and all of the trajectory candidates lc to the information processing apparatus 2A, the selected pieces of sensor data ssd and the trajectory group lcg that includes the trajectory candidates lc based on the correlation among the generated at least one trajectory candidate lc are output to the information processing apparatus 2A. Therefore, in the information processing system 3A, a small amount of data is referred to in order to generate the consolidation trajectory clc. Thus, it is possible to perform low-load processing for tracking the target object.

### (Variation)

In the information processing system 3A, the information processing system 1A may be configured not to include the trajectory group generation unit 14.

In this case, the output unit 15 outputs, to the information processing apparatus 2A, the pieces of sensor data ssd that have been selected by the selection unit 13. In a case where the acquisition unit 21 of the information processing apparatus 2A acquires the pieces of sensor data ssd that have been output from the information processing system 1A, the update unit 22 updates the trajectory of the target object TO with reference to the pieces of sensor data ssd to generate at least one consolidation trajectory clc at the time t.

Further, as described above, the configuration may be employed in which the prediction unit 23 of the information processing apparatus 2A predicts at least one consolidation trajectory clc of the target object TO at the time t+1 with reference to the at least one consolidation trajectory clc at the time t, and the output unit 24 outputs, to the information processing system 1A, a predicted consolidation trajectory group pclcg that includes at least one predicted consolidation trajectory pclc.

This configuration allows the information processing system 3A to generate at least one consolidation trajectory clc with reference to the selected pieces of sensor data ssd. Thus, it is possible to track a target object at lower load and with a higher degree of accuracy.

### [Software Implementation Example]

Some or all of the functions of the information processing systems 1, 1A, 3, 3A and the information processing apparatuses 2, 2A (hereinafter also referred to as “the above-described systems and apparatuses”) can be realized by hardware such as an integrated circuit (IC chip) or can be alternatively realized by software.

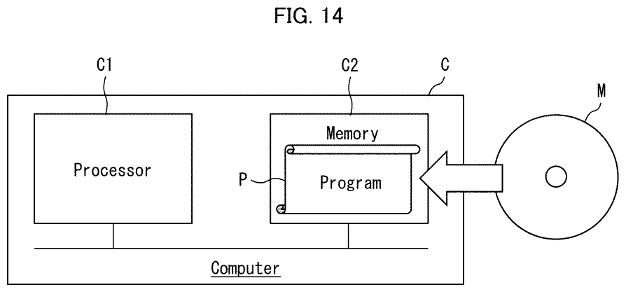

In the latter case, the above-described systems and apparatuses are each realized by, for example, a computer that executes instructions of a program that is software realizing the foregoing functions. FIG. 14 illustrates an example of such a computer (hereinafter referred to as “computer C”). FIG. 14 is a block diagram illustrating a hardware configuration of the computer C that functions as the above-described systems and apparatuses.

The computer C includes at least one processor C1 and at least one memory C2. The at least one memory C2 stores a program P for causing the computer C to operate as the above-described systems and apparatuses. In the computer C, the processor C1 reads the program P from the memory C2 and executes the program P, so that the functions of the above-described systems and apparatuses are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded at the execution of the program P and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remarks]

The present disclosure includes the techniques described in the supplementary notes below. Note, however, that the present invention is not limited to the techniques described in the supplementary notes below, but may be altered in various ways by a skilled person within the scope of the claims.

### (Supplementary Note 1)

An information processing system including:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors;
a trajectory group generation means for generating a trajectory group of the target object in accordance with a correlation between the trajectory candidates corresponding to respective ones of the plurality of sensors; and
an output means for outputting the selected pieces of sensor data and the trajectory group.

### (Supplementary Note 2)

The information processing system described in supplementary note 1, wherein:
the information processing system further includes a consolidation trajectory group acquisition means for acquiring a predicted consolidation trajectory group, the predicted consolidation trajectory group being at least one trajectory of the target object that is predicted with reference to the trajectory group and the pieces of sensor data both of which have been output in a past by the output means; and
the selection means selects the piece of sensor data indicating the position of the target object with further reference to the at least one trajectory which is included in the predicted consolidation trajectory group.

### (Supplementary Note 3)

The information processing system described in supplementary note 1 or 2, wherein the output means outputs the selected pieces of sensor data and trajectory candidates which are included in the trajectory group and which correspond to respective ones of the selected pieces of sensor data in such a manner that the selected pieces of sensor data and the corresponding trajectory candidates included in the trajectory group are associated with each other.

### (Supplementary Note 4)

The information processing system described in supplementary note 1 or 2, wherein:
the information processing system further includes a sensor data group generation means for generating a sensor data group in accordance with a correlation between the pieces of sensor data that have been selected by the selection means and that correspond to the respective ones of the plurality of sensors; and
the output means outputs the trajectory group and the sensor data group.

### (Supplementary Note 5)

The information processing system described in any of supplementary notes 1 to 4, wherein the selection means selects the piece of sensor data indicating the position of the target object in accordance with a degree of distribution of pieces of sensor data that are present around the position of the target object indicated by the trajectory candidate related to the target object.

### (Supplementary Note 6)

The information processing system described in any of supplementary notes 1 to 5, wherein the trajectory group generation means generates the trajectory group that includes a plurality of trajectory candidates which have a high degree of similarity among degrees of similarities between the trajectory candidates corresponding to the respective ones of the plurality of sensors.

### (Supplementary Note 7)

An information processing apparatus including:
an acquisition means for acquiring:
pieces of sensor data that have been selected as sensor data indicating a position of a target object from among respective pluralities of pieces of sensor data which have been acquired from a plurality of sensors that detect a position of the target object; and
a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object;
an update means for updating a trajectory of the target object with reference to the selected pieces of sensor data and the trajectory group of the target object;
a prediction means for predicting at least one future trajectory of the target object with reference to the updated trajectory; and
an output means for outputting a predicted consolidation trajectory group, which is the at least one trajectory having been predicted by the prediction means, to an apparatus that selects the pieces of sensor data and an apparatus that generates the trajectory group of the target object.

### (Supplementary Note 8)

An information processing system including:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors;
a trajectory group generation means for generating a trajectory group of the target object in accordance with a correlation between the trajectory candidates corresponding to respective ones of the plurality of sensors;
an update means for updating a trajectory of the target object with reference to the selected pieces of sensor data and the trajectory group; and
a prediction means for predicting at least one future trajectory of the target object with reference to the updated trajectory.

### (Supplementary Note 9)

An information processing method including:
an acquisition process for at least one processor acquiring respective pluralities of pieces of sensor data from a plurality of sensors that detect a position of a target object;
a trajectory candidate generation process, which is carried out for each of the plurality of sensors, for the at least one processor generating at least one trajectory candidate related to the target object with reference to pieces of sensor data that have been acquired in a past from each of the plurality of sensors and that each indicate a position of the target object;
a selection process, which is carried out for each of the plurality of sensors, for the at least one processor selecting, with reference to the at least one trajectory candidate related to the target object, a piece of sensor data indicating the position of the target object from among the pieces of sensor data that have been acquired from each of the plurality of sensors;
a trajectory group generation process for the at least one processor generating a trajectory group of the target object in accordance with a correlation between the trajectory candidates corresponding to respective ones of the plurality of sensors; and
an output process for the at least one processor outputting the selected pieces of sensor data and the trajectory group.

### (Supplementary Note 10)

An information processing program causing a computer to function as:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors;
a trajectory group generation means for generating a trajectory group of the target object in accordance with a correlation between the trajectory candidates corresponding to respective ones of the plurality of sensors; and
an output means for outputting the selected pieces of sensor data and the trajectory group.

### (Supplementary Note 11)

The information processing system described in supplementary note 6, wherein the trajectory group generation means generates the trajectory group of the target object in accordance with a correlation between the selected pieces of sensor data corresponding to the respective ones of the plurality of sensors.

### (Supplementary Note 12)

The information processing apparatus described in any of supplementary notes 1 to 6 and 7, wherein the target object is at least one selected from the group consisting of an object moving in air, an object moving on ground, a person moving on ground, and an object moving on water.

### (Supplementary Note 13)

An information processing method including:
an acquisition process for at least one processor acquiring:
pieces of sensor data that have been selected as sensor data indicating a position of a target object from among respective pluralities of pieces of sensor data which have been acquired from a plurality of sensors that detect a position of the target object; and
a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object;
an update process for the at least one processor updating a trajectory of the target object with reference to the selected pieces of sensor data and the trajectory group of the target object; and
a prediction process for the at least one processor predicting at least one future trajectory of the target object with reference to the updated trajectory.

### (Supplementary Note 14)

An information processing method including:
an acquisition process for at least one processor acquiring respective pluralities of pieces of sensor data from a plurality of sensors that detect a position of a target object;
a trajectory candidate generation process, which is carried out for each of the plurality of sensors, for the at least one processor generating at least one trajectory candidate related to the target object with reference to pieces of sensor data that have been acquired in a past from each of the plurality of sensors and that each indicate a position of the target object;
a selection process, which is carried out for each of the plurality of sensors, for the at least one processor selecting, with reference to the at least one trajectory candidate related to the target object, a piece of sensor data indicating the position of the target object from among the pieces of sensor data that have been acquired from each of the plurality of sensors;
a trajectory group generation process for the at least one processor generating a trajectory group of the target object in accordance with a correlation between the trajectory candidates corresponding to respective ones of the plurality of sensors;
an update process for the at least one processor updating a trajectory of the target object with reference to the selected pieces of sensor data and the trajectory group; and
a prediction process for the at least one processor predicting at least one future trajectory of the target object with reference to the updated trajectory.

### (Supplementary Note 15)

An information processing program causing a computer to function as:
an acquisition means for acquiring:
pieces of sensor data that have been selected as sensor data indicating a position of a target object from among respective pluralities of pieces of sensor data which have been acquired from a plurality of sensors that detect a position of the target object; and
a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object;
an update means for updating a trajectory of the target object with reference to the selected pieces of sensor data and the trajectory group of the target object; and
a prediction means for predicting at least one future trajectory of the target object with reference to the updated trajectory.

### (Supplementary Note 16)

An information processing program causing a computer to function as:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors;
a trajectory group generation means for generating a trajectory group of the target object in accordance with a correlation between the trajectory candidates corresponding to respective ones of the plurality of sensors;
an update means for updating a trajectory of the target object with reference to the selected pieces of sensor data and the trajectory group; and
a prediction means for predicting at least one future trajectory of the target object with reference to the updated trajectory.

### (Supplementary Note 17)

An information processing system including:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors; and
an output means for outputting the selected pieces of sensor data.

### (Supplementary Note 18)

An information processing method comprising:
an acquisition process for at least one processor acquiring respective pluralities of pieces of sensor data from a plurality of sensors that detect a position of a target object;
a trajectory candidate generation process, which is carried out for each of the plurality of sensors, for the at least one processor generating at least one trajectory candidate related to the target object with reference to pieces of sensor data that have been acquired in a past from each of the plurality of sensors and that each indicate a position of the target object;
a selection process, which is carried out for each of the plurality of sensors, for the at least one processor selecting, with reference to the at least one trajectory candidate related to the target object, a piece of sensor data indicating the position of the target object from among the pieces of sensor data that have been acquired from each of the plurality of sensors; and
an output process for the at least one processor outputting the selected pieces of sensor data.

### (Supplementary Note 19)

An information processing program causing a computer to function as:
an acquisition means for acquiring respective pluralities of pieces of sensor data from a plurality of sensors that detect a position of a target object;
a trajectory candidate generation means for, for each of the plurality of sensors, generating at least one trajectory candidate related to the target object with reference to pieces of sensor data that have been acquired in a past from each of the plurality of sensors and that each indicate a position of the target object;
a selection means for, for each of the plurality of sensors, selecting, with reference to the at least one trajectory candidate related to the target object, a piece of sensor data indicating the position of the target object from among the pieces of sensor data that have been acquired from each of the plurality of sensors; and
an output means for outputting the selected pieces of sensor data.

### REFERENCE SIGNS LIST

1, 1A, 3, 3A: information processing system
1_1A, 1_2A, 1_3A, 2, 2A: information processing apparatus
10_1A, 20: control unit
11, 21: acquisition unit
11_1A, 25: storage unit
12: trajectory candidate generation unit
12_1A, 26: input/output unit
13: selection unit
13_1A, 27: communication unit
14: trajectory group generation unit
15, 24: output unit
16: sensor data group generation unit
22: update unit
23: prediction unit
SN: sensor
clc: consolidation trajectory
lc: trajectory candidate
lcg: trajectory group
pclc: predicted consolidation trajectory
pclcg: predicted consolidation trajectory group
sd, ssd: sensor data
ssdg: sensor data group
pp: position

1. An information processing system comprising at least one processor, the at least one processor carrying out:
an acquisition process for acquiring respective pluralities of pieces of sensor data from a plurality of sensors that detect a position of a target object;
a trajectory candidate generation process, which is carried out for each of the plurality of sensors, for generating at least one trajectory candidate related to the target object with reference to pieces of sensor data that have been acquired in a past from each of the plurality of sensors and that each indicate a position of the target object;
a selection process, which is carried out for each of the plurality of sensors, for selecting, with reference to the at least one trajectory candidate related to the target object, a piece of sensor data indicating the position of the target object from among the pieces of sensor data that have been acquired from each of the plurality of sensors;
a trajectory group generation process for generating a trajectory group of the target object in accordance with a correlation between the trajectory candidates corresponding to respective ones of the plurality of sensors; and
an output process for outputting the selected pieces of sensor data and the trajectory group.

2. The information processing system according to claim 1, wherein:
the at least one processor further carries out a consolidation trajectory group acquisition process for acquiring a predicted consolidation trajectory group, the predicted consolidation trajectory group being at least one trajectory of the target object that is predicted with reference to the trajectory group and the pieces of sensor data both of which have been output in a past in the output process; and
in the selection process, the at least one processor selects the piece of sensor data indicating the position of the target object with further reference to the at least one trajectory which is included in the predicted consolidation trajectory group.

3. The information processing system according to claim 1, wherein, in the output process, the at least one processor outputs the selected pieces of sensor data and trajectory candidates which are included in the trajectory group and which correspond to respective ones of the selected pieces of sensor data in such a manner that the selected pieces of sensor data and the corresponding trajectory candidates included in the trajectory group are associated with each other.

4. The information processing system according to claim 1, wherein:
the at least one processor further carries out a sensor data group generation process for generating a sensor data group in accordance with a correlation between the pieces of sensor data that have been selected in the selection process and that correspond to the respective ones of the plurality of sensors; and
in the output process, the at least one processor outputs the trajectory group and the sensor data group.

5. The information processing system according to claim 1, wherein, in the selection process, the at least one processor selects the piece of sensor data indicating the position of the target object in accordance with a degree of distribution of pieces of sensor data that are present around the position of the target object indicated by the trajectory candidate related to the target object.

6. The information processing system according to claim 1, wherein, in the trajectory group generation process, the at least one processor generates the trajectory group that includes a plurality of trajectory candidates which have a high degree of similarity among degrees of similarities between trajectory the candidates corresponding to the respective ones of the plurality of sensors.

7. An information processing apparatus comprising at least one processor, the at least one processor carrying out:
an acquisition process for acquiring:
pieces of sensor data that have been selected as sensor data indicating a position of a target object from among respective pluralities of pieces of sensor data which have been acquired from a plurality of sensors that detect a position of the target object; and
a trajectory group of the target object that has been generated in accordance with a correlation between trajectory candidates related to the target object, the trajectory candidates each being at least one trajectory candidate that has been generated, for each of the plurality of sensors, with reference to pieces of sensor data that have been acquired in a past from each of the plurality of sensors and that each indicate the position of the target object;
an update process for updating a trajectory of the target object with reference to the selected pieces of sensor data and the trajectory group of the target object;
a prediction process for predicting at least one future trajectory of the target object with reference to the updated trajectory; and
an output process for outputting a predicted consolidation trajectory group, which is the at least one trajectory having been predicted in the prediction process, to an apparatus that selects the pieces of sensor data and an apparatus that generates the trajectory group of the target object.

8. An information processing method comprising:
an acquisition process for at least one processor acquiring respective pluralities of pieces of sensor data from a plurality of sensors that detect a position of a target object;
a trajectory candidate generation process, which is carried out for each of the plurality of sensors, for the at least one processor generating at least one trajectory candidate related to the target object with reference to pieces of sensor data that have been acquired in a past from each of the plurality of sensors and that each indicate a position of the target object;
a selection process, which is carried out for each of the plurality of sensors, for the at least one processor selecting, with reference to the at least one trajectory candidate related to the target object, a piece of sensor data indicating the position of the target object from among the pieces of sensor data that have been acquired from each of the plurality of sensors;
a trajectory group generation process for the at least one processor generating a trajectory group of the target object in accordance with a correlation between the trajectory candidates corresponding to respective ones of the plurality of sensors; and
an output process for the at least one processor outputting the selected pieces of sensor data and the trajectory group.

9. A computer-readable non-transitory storage medium storing an information processing program for causing a computer to function as an information processing system recited in claim 1, the information processing program causing the computer to carry out the acquisition process, the trajectory candidate generation process, the selection process, the trajectory group generation process, and the output process.
